(19) United States
(12) Patent Application Publication
(10) Pub. No.: US 2011/0058199 A1
(43) Pub. Date: Mar. 10, 2011

(54) Printer driver, information processing apparatus, and program product storing printer driver therein

(75) Inventor: Hiroto Kobayashi, Saitama (JP)

(73) Assignee: Ricoh Company, Ltd, Tokyo (JP)

(21) Appl. No.: 12/923,052

(22) Filed: Aug. 31, 2010

(30) Foreign Application Priority Data
Sep. 8, 2009 (JP) 2009-207266

(51) Int. Cl. H04N 1/60

(52) U.S. Cl. 358/1.9

(57) ABSTRACT

A printer driver adapting to a plurality of models of printers includes a function management unit that determines an available function based on function information including a constraint on a print setting, a print setting unit that generates a print setting screen based on a determination result from the function controlling unit, and a drawing unit that generates print data in response to a request to print drawing data. The function management unit determines whether a print setting value set for the drawing data conforms to the constraint, when the drawing unit responds to the request to print the drawing data. The drawing unit generates print data based on the determination result from the function management unit.

### CROSS-REFERENCE TO RELATED APPLICATIONS

The present application claims priority to and incorporates by reference the entire contents of Japanese Patent Application No. 2009-207266 filed in Japan on Sep. 8, 2009.

### BACKGROUND OF THE INVENTION

1. Field of the Invention

The present invention relates to a printer driver, an information processing apparatus, and a program product storing the printer driver therein.

2. Description of the Related Art

Printers differ in function according to the model, and functions of printers may be expanded by adding options. To respond to such circumstances, a technology of generating data that can be processed by printing apparatuses without expanding the functions of the printing apparatuses has been proposed. For example, in a technology disclosed in Japanese Patent Application Laid-open No. 2008-097574, an area is secured in a data structure (such as Devmode structure) for storing therein print setting, and a print setting value, that is set on the basis of function setting information on functions of a printing apparatus, is assigned to the area. Data that can be processed by printing apparatuses is generated from the print setting value assigned to the data structure, by referring, to the function setting information. In the technology disclosed in Japanese Patent Application Laid-open No. 2008-097574, with such a configuration, data that can be processed by printing apparatuses is generated without expanding the functions of the printing apparatus.

A technology called a universal driver has been known, that is capable of outputting print data to a plurality of types of printers from one printer driver.

The contents of print setting specified by a user using an application on an information processing apparatus in which a printer driver is installed, are transferred from a print setting unit of the printer driver that controls displaying a print setting screen to a drawing unit of the printer driver. The drawing unit of the printer driver generates print data, based on the print setting received from the print setting unit of the printer driver. Before generating the print data, the drawing unit determines whether the received print setting is valid (e.g., determine whether a plurality of print settings can be set simultaneously). If the print setting is not valid, a function for correcting the setting (in the present specification, referred to as validity confirming unit) is available.

In the conventional printer driver for each model, the functions do not increase or decrease (e.g., as long as the options are not changed). Accordingly, the validity confirming unit is incorporated in the drawing unit of the printer driver to use the functions of the model.

However, in printer drivers such as the universal driver, the printers to be used may be changed, or the functions of the printers being connected may be expanded. Accordingly, the validity confirming unit relative to print setting must be incorporated in the drawing unit, so that all the functions of all the models supported can be used. In other words, the printer driver must include the validity confirming unit that can confirm the validity of the print setting relative to all the functions of all the models supported. Even if a printer driver only supports one model, if the available functions are changed according to the options of the printer, the printer driver needs to similarly include the similar validity confirming unit.

Accordingly, the validity confirming unit also needs to add corresponding modules, based on the increase in the number of printers supported and the functions of the printer. Validity confirming unit is often hard-coded and must be recompiled to add modules. The added printer driver needs to be redistributed to the user and reinstalled by the user.

### SUMMARY OF THE INVENTION

It is an object of the present invention to at least partially solve the problems in the conventional technology.

According to an aspect of the present invention, there is provided a printer driver adapting to a plurality of models of printers, the printer driver comprising: a function management unit that determines an available function based on function information including a constraint on a print setting; a print setting unit that generates a print setting screen based on a determination result made by the function management unit; and a drawing unit that generates print data in response to a request to print drawing data; wherein the function management unit determines whether a print setting value set for the drawing data conforms to the constraint, when the drawing unit responds to the request to print the drawing data, and the drawing unit generates print data based on determination result made by the function management unit.

According to another aspect of the present invention, there is provided a program product comprising: a printer driver being stored in the program product, the printer driver adapting to a plurality of models of printers, and comprising: a function management unit that determines an available function based on function information including a constraint on a print setting; a print setting unit that generates a print setting screen based on a determination result made by the function management unit; and a drawing unit that generates print data in response to a request to print drawing data, wherein the function management unit determines whether a print setting value set for the drawing data conforms to the constraint, when the drawing unit responds to the request to print the drawing data, and the drawing unit generates print data based on determination result made by the function management unit.

According to still another aspect of the present invention, there is provided an information processing apparatus comprising: a printer driver adapting to a plurality of models of printers, the printer driver comprising: a function management unit that determines an available function based on function information including a constraint on a print setting; a print setting unit that, generates a print setting screen based on a determination result made by the function management unit; and a drawing unit that generates print data in response to a request to print drawing data, wherein the function management unit determines whether a print setting value set for the drawing data conforms to the constraint, when the drawing unit responds to the request to print the drawing data, and the drawing unit generates print data based on determination result made by the function management unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of an overall configuration of a printer system using an information processing apparatus having a printer driver according to an embodiment of the present invention;

FIG. 2 is a schematic of a personal computer (PC) that corresponds to the information processing apparatus in the embodiment;

FIG. 3 is a schematic of a relationship between function information for each model and a function management unit that reads out function information;

FIG. 4 is a schematic of a print setting unit and a drawing unit that can receive and send information through a DEVMODE structure;

FIG. 5 is a schematic of an example of layout information;

FIG. 6 is a schematic of an example of a print setting screen based on the layout information in FIG. 5;

FIG. 7 is a schematic of an example of function information;

FIG. 8 is a flowchart for explaining an operation performed by the drawing unit; and

FIG. 9 is a sequence diagram for explaining an operation performed by a printer driver relative to a print setting screen calling request and a print request from an application.

### DETAILED DESCRIPTION OF THE PREFERRED EMBODIMENTS

Exemplary embodiments of the present invention will be described below in greater detail with reference to the accompanying drawings.

Overall Configuration of Printer System

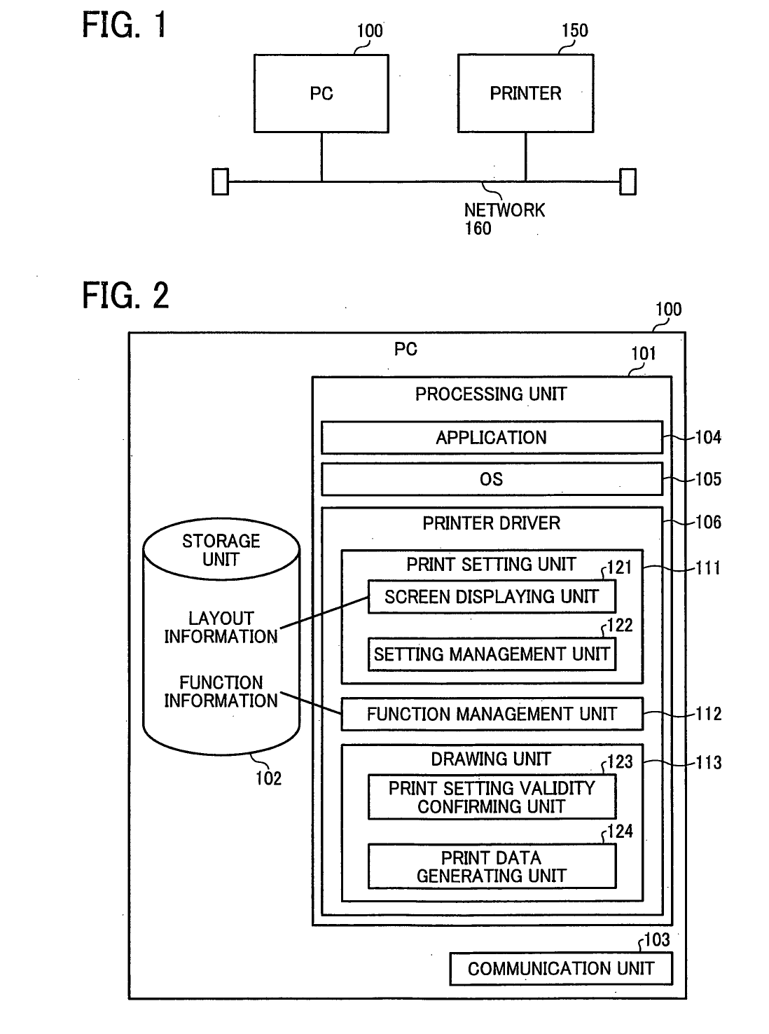

FIG. 1 is a schematic of an overall configuration of a printer system using an information processing apparatus having a printer driver according to an embodiment of the present invention. As illustrated in FIG. 1, in the present embodiment, a personal computer (PC) 100 that corresponds to the information processing apparatus and a printer 150 are connected through a network 160. The printer 150 performs a printing operation in response to a print request from the PC 100.

Configuration of PC 100

FIG. 2 is a schematic of the PC 100. As illustrated in FIG. 2, the PC 100 includes a processing unit 101, a storage unit 102, and a communication unit 103. The processing unit 101 includes a central processing unit (CPU) and a memory group, which are not shown. The CPU serves as a controlling unit, and the memory group includes a read only memory (ROM) and a random access memory (RAM) serving as a main memory. When the PC 100 is started and starts running, an application 104, an operating system (OS) 105, and various drivers (only a printer driver 106 is shown in FIG. 2) are loaded from the ROM and the storage unit 102, and are developed on the main memory. Accordingly, the application 104, the OS 105, and the various drivers are executed by the CPU. The PC 100 has a hardware configuration using a conventional computer including an input device such as a keyboard and a mouse, and an output device such as a display. However, the input device and the output device are omitted in FIG. 2 for ease of explanation.

Each function block in the printer driver 106 shown in FIG. 2 is a function or unit serving as a main portion for controlling the printer 150.

The communication unit 103 sends and receives information with the connected printer 150 through the network 160.

The application 104 is software by which a user can instruct printing. If a user desires to print data being edited by the application 104, the application 104 receives a print instruction from the user. In this case, the application 104 does not generate print data to be sent to the printer 150 alone, but transmits information on an object to be printed to the OS 105, with a print request in response to the print instruction.

The OS 105 is a computer program for managing the hardware and software of the PC 100. The OS 105 starts programs, reads information, stores therein the information, and the like. Typical examples of OS are MS Windows (registered trademark) and UNIX (registered trademark). The OS 105 sends information of an object to be printed (such as document data and image data) to the printer driver 106 with the print request received from the application 104.

The storage unit 102 is a storage unit that stores therein various types of information. More specifically, the storage unit 102 is a hard disk drive (HDD) and the like. Information to be stored includes setting information that defines information related to processing for realizing functions of the printer driver 106. The setting information is various types of information required for processing such as setting values used for processing and display information used to change the setting values. Examples of the setting information are layout information, function information, and the like.

The layout information is information describing a layout of graphical user interface (GUI) components displayed on a setting screen. The function information is information describing ranges within which the setting values can be set and constraints between each settings. The information will hereinafter be described in detail.

The printer driver 106 includes a print setting unit 111 that controls a user interface (UI), a function management unit 112 that integrally performs processes to determine the validity of the print setting, and a drawing unit 113 that controls the drawing as a module being referable to a module group for executing the functions of the driver.

The print setting unit 111 includes a screen displaying unit 121 and a setting management unit 122.

The screen displaying unit 121 controls the display of the GUI (print setting screen) displayed on a monitor screen as the UI. The screen displaying unit 121 according to the present embodiment displays a print setting screen based on the layout information stored in the storage unit 102.

The setting management unit 122 stores setting values managed by the setting management unit 122 into a data storage area such as the Devmode structure, registry, and the like, provided by the OS 105. The setting management unit 122 also confirms the available functions by calling the function controlling unit 112 as described below, and receiving a determination result of the validity of the functions of the printer 150. The determination result from the function management unit 112 is reflected on the print setting screen displayed by the screen displaying unit 121, and for example, only available functions may be displayed.

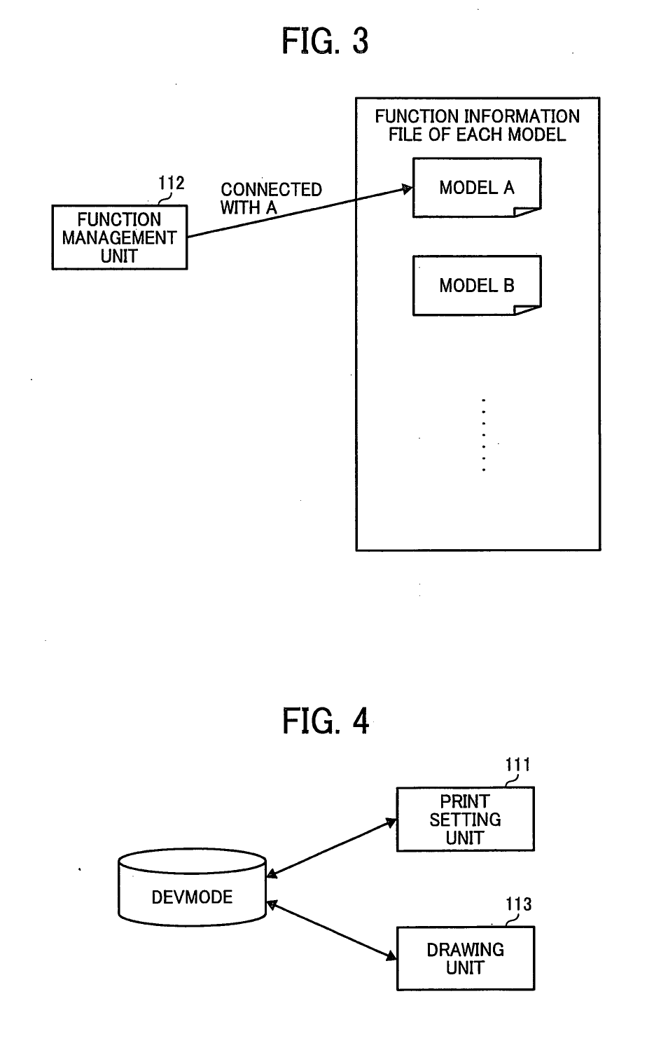

The function management unit 112 refers (see FIG. 3) the function information (information related to the specifications of the printer and information used to evaluate the validity) stored in the storage unit 102 for each model, and determines the available functions of the printer 150 currently being connected and determines the validity of the print setting.

The drawing unit 113 includes a print setting validity confirming unit 123 and a print data generating unit 124.

The print setting validity confirming unit 123 calls the function management unit 112, and confirms the validity of the print setting, by receiving the evaluation result of the validity of the print setting (current value) sent from the print setting unit 111 through the Devmode structure. As shown in FIG. 4, the print setting unit 111 and the drawing unit 113 can receive and send information through the Devmode structure.

The print data generating unit 124 generates print data interpretable by the printer 150 from data requested to be printed from the application 104 on the basis of the print setting. The print data generating unit 124 then transmits the generated print data to the printer 150 through the communicating unit 103. The print data generating unit 124 generates print data reflecting the results confirmed by the print setting validity confirming unit 123.

Specific examples of the setting information (layout information and function information) will now be described.

Layout Information

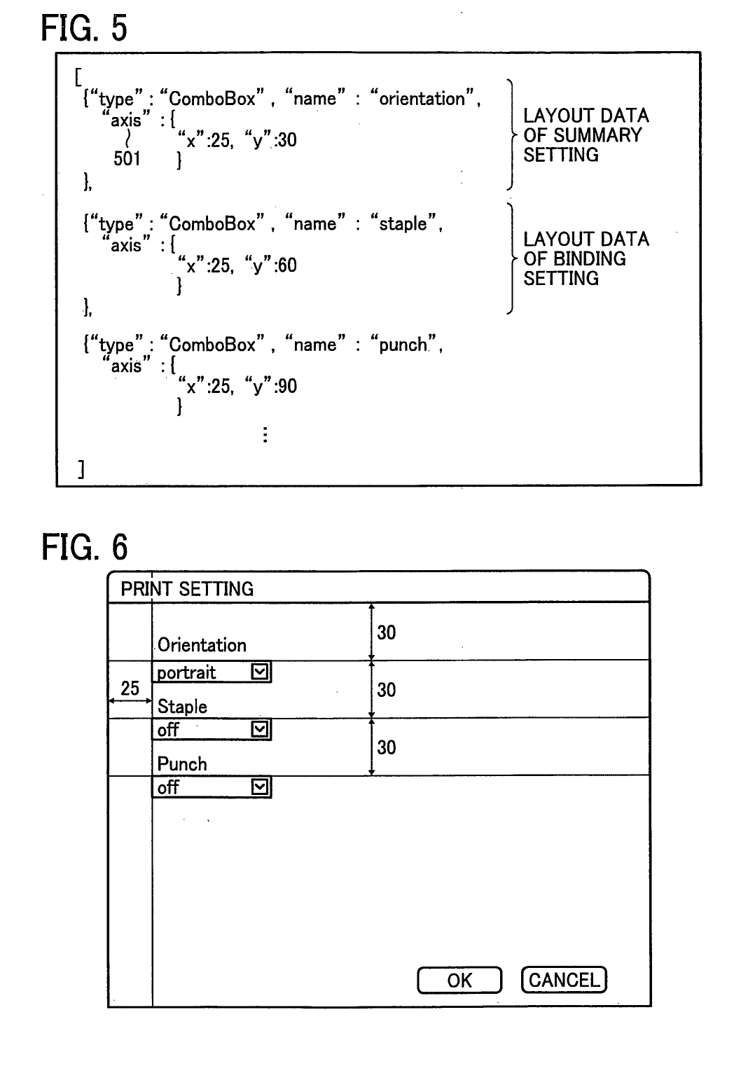

FIG. 5 is a schematic of an example of layout information. The layout information shown in FIG. 5 is layout information of the printer driver 106, and only a part thereof is shown by an example. The layout information shown in FIG. 5 is described in JavaScript Object Notation (JSON) format. However, other formats may also be used.

As shown in FIG. 5, the layout information includes layout data of the GUI components displayed on the print setting screen. The layout data includes type, name, and axis as attributes thereof.

Type indicates the type of the GUI component. ComboBox corresponds to a value of type and indicates that the GUI component is displayed in a combo box component. Although not shown, the GUI component can also be displayed in a check box component, a spin box component, an edit box component, and the like, by describing CheckBox, SpinBox, EditBox, and the like.

Name indicates the name of setting. In the values of name, orientation indicates that it is the setting of print orientation, staple indicates that it is the setting of stapling, and punch indicates that it is the setting of punching. Although not shown, the size of paper, the number of copies, and the like can also be specified by describing paper size, copies, and the like.

Axis is the coordinate at which the GUI component is displayed. X and y are attributes of axis, and x indicates the coordinate in the horizontal direction from the origin at the upper left of the dialogue box, and y indicates the coordinate in the vertical direction from the origin at the upper left in the dialogue box. For example, in an axis 501 for setting the print orientation (orientation) shown in FIG. 5, it is described that a combo box component specified by the attribute type is displayed at the horizontal position of 25 and the vertical position of 30.

The screen displaying unit 121 reads layout information from the storage unit 102, generates a setting screen based on the read layout information, and displays the generated print setting screen on a display device (not shown) of the PC 100. At this time, under the control of the setting management unit 122, the screen displaying unit 121 only displays settable items that are managed by the function management unit 112 based on the following function information among the GUI components described in the layout information.

FIG. 6 is a schematic of an example of a print setting screen displayed by the screen displaying unit 121 of the printer driver 106, when the layout information in FIG. 5 is read. As shown in FIG. 6, a display name “Orientation” for setting the print orientation is arranged with a combo box component, a display name “Staple” for setting stapling is arranged with a combo box component, and a display name “Punch” for setting punching is arranged with a combo box component. OK button shown in FIG. 6 is a button for storing the changed print setting, and Cancel button is a button for cancelling the change.

Function Information

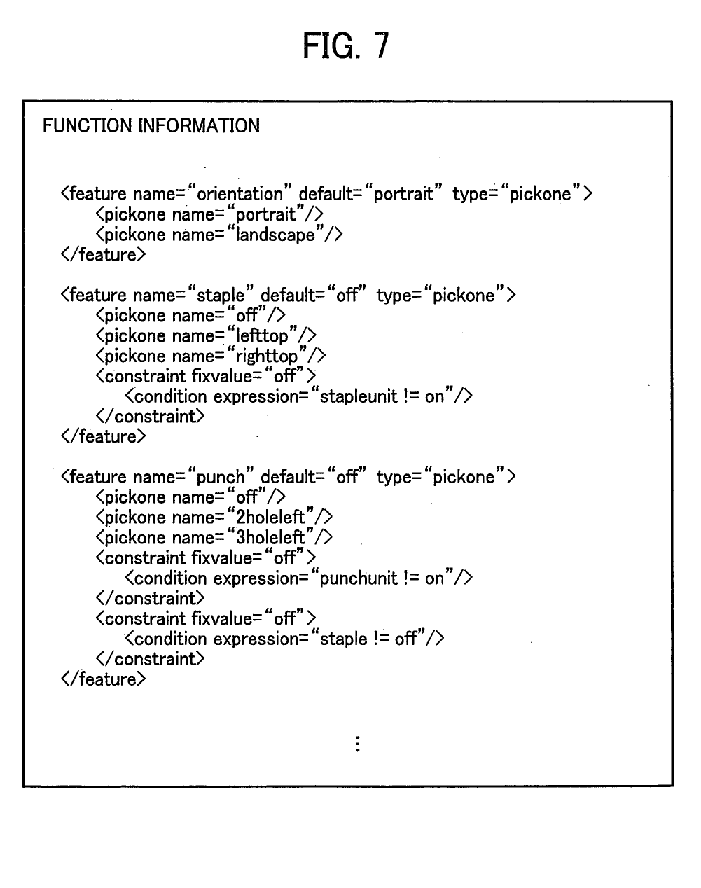

FIG. 7 is a schematic of an example of function information. In FIG. 7, for ease of explanation, only the setting of print orientation (orientation), the setting of stapling (staple), and the setting of punching (punch) are shown. However, because the function information describes ranges within which setting values can be set, and constraints on the settings, and the like, in practice, the function information includes descriptions on various settings related to printing such as the setting of the size of paper and the setting of the number of copies. The function information illustrated in FIG. 7 is described in Extensible Markup Language (XML) format. However, other formats (such as JSON) may also be used.

In the example of function information illustrated in FIG. 7, each setting information is defined by the feature tag. Each of the feature tags has name, default, and type as attributes thereof. The example illustrated in FIG. 7 is only an example, and it is also possible to define and use other attributes.

The attribute name is the name of the setting, and corresponds to name of the layout information. In the example shown in FIG. 7, in the values of name, orientation that corresponds to the values of attribute name indicates the setting of print orientation, similarly, staple indicates the setting of stapling, and punch indicates the setting of punching. The attribute default indicates the initial value of the option. The attribute type indicates the format of the setting value to be input. Pickone is a value of type, and specifies the option format. Other than this pickone, string specifies the character string input format, number specifies the number input format, and the like.

As the setting of stapling shown in FIG. 7, a constraint tag can be described in a portion enclosed by the feature tags. The portion described by using the constraint tag is constraint information on the setting of the feature tag that corresponds to the parent tag. An attribute fixvalue in the constraint tag indicates a setting value forcibly changed when the constraints conditions are coincided.

As the setting of stapling (staple) in FIG. 7, a condition tag can be described in a portion enclosed by the constraint tags. The condition tag indicates the constraint conditions on the constraint tag that corresponds to the parent tag, and the conditions of the constraint tag are specified by an attribute expression.

In the setting of stapling illustrated in FIG. 7, for example, when stapleunit is other than on (in other words, when a staple unit cannot be used as the specification of the printer 150), the constraint conditions are coincided, and the setting value of staple (setting of stapling) is forcibly changed to off.

In the setting of punching shown in FIG. 7, when punchunit is other than on (in other words, when a punchunit cannot be used as the specification of the printer 150), the constraint conditions are coincided, and the setting value of punch (setting of punching) is forcibly changed to off. If staple (setting of stapling) is other than off, the constraints are also satisfied, and the setting value of punch (setting of punching) is forcibly changed to off.

The pickone tag indicates a selectable setting value, and the setting value is set by the attribute name in the pickone tag. Although not illustrated in FIG. 7, the constraint tag can also be described in a portion enclosed by the pickone tags, and the pickone tag itself, namely, an option itself may also include constraint information.

Portrait and landscape are values of names that corresponds to the attributes of pickone. Portrait indicates the vertical direction and landscape indicates the horizontal direction in the setting of the print orientation. In the setting of stapling, off indicates turn off of the function, lefttop indicates the upper left, and righttop indicates the upper right. In the setting of punching, off indicates turn off of the function, 2holeleft indicates two holes at the left side, and 3holeleft indicates three holes at the left side.

As described above, the function information includes information with which the function management unit 112 of the printer driver 106 manages the settings related to printing. The function information is prepared for each model of the printer supported, and all the functions of the printers including the options are described in the function information. The function controlling unit 112 refers to the function information, and integrally determines the available functions and evaluates the validity of the setting value (current value).

Operation Performed by Drawing Unit

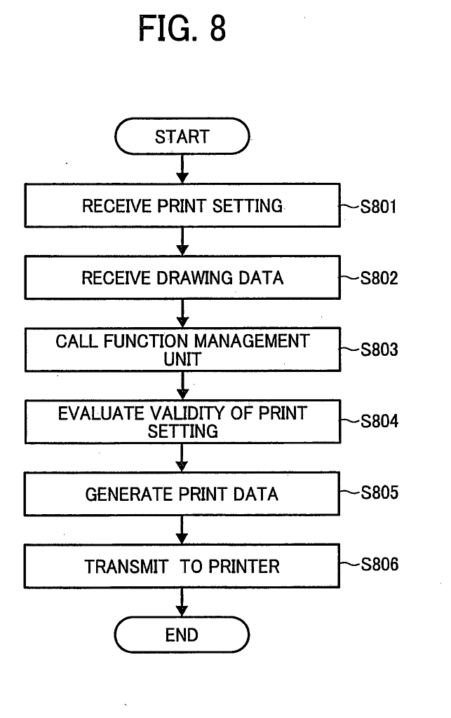

An operation performed by the drawing unit 113 of the printer driver 106 of the present embodiment will now be described with reference to FIG. 8. FIG. 8 is a flowchart for explaining the operation performed by the drawing unit 113.

The drawing unit 113 receives print setting (current value) from the Devmode structure in which print setting is stored, in response to a print request from the application 104 (Step S801). The print setting is information including contents of print setting performed by the user on the print setting unit 111 called from the application 104.

The drawing unit 113 also receives drawing data of an object to be printed from the application 104 (Step S802).

When the drawing unit 113 receives the print setting and the drawing data, the print setting validity confirming unit 123 of the drawing unit 113 calls the function management unit 112 (Step S803). The called function management unit 112 determines the validity of the print setting (current value) and sends the determination result to the print setting validity confirming unit 123.

The print setting validity confirming unit 123 performs a validity evaluation that is to confirm the validity of the print setting (current value) received at Step S801, based on the determination result received from the function management unit 112 (Step S804).

The print data generating unit 124 of the drawing unit 113 generates print data based on the print setting (corrected value) in which the validity evaluation (in other words, determination result by the function controlling unit 112) by the print setting validity confirming unit 123 is reflected (Step S805).

Finally, the print data generating unit 124 transmits the generated print data to the printer 150 (Step S806).

The operation performed by the drawing unit 113 of the printer driver 106 has been described.

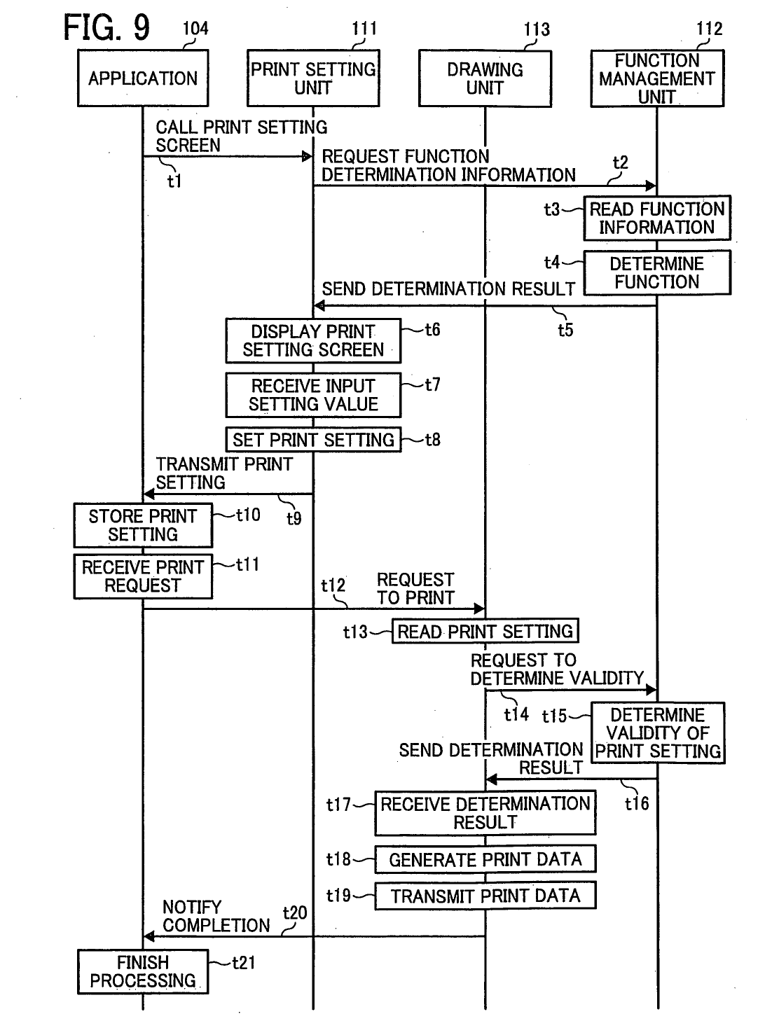

With reference to a sequence diagram in FIG. 9, operations in the printer driver 106 relative to a print setting screen calling request and a print request from the application 104 are described in correlation with the operation performed by the application 104.

When the user sends a print setting request to the printer 150, a print setting screen calling request is sent to the print setting unit 111 from the application 104, to display a print setting screen for setting the printer 150 to print (t1).

The print setting unit 111 receives the print setting screen calling request from the application 104, and sends a function determination information request to the function management unit 112 to determine available functions of the printer 150 (t2).

The function management unit 112 receives the request from the print setting unit 111, and reads out function information of the printer 150 stored in the storage unit 102 (t3).

The function management unit 112 determines the available functions in the printer 150 (t4) on the basis of the read function information. The function management unit 112 then sends the determination result to the print setting unit 111 as function determination information (t5).

When the print setting unit 111 receives the function determination information from the function management unit 112, the screen displaying unit 121 of the print setting unit 111 generates a setting screen for setting various functions of the printer 150, based on the function determination information and the layout information, and displays the setting screen on a displaying unit (not shown) of the PC 100 (t6).

The print setting unit 111 then receives a print setting value relative to the printer 150, input by the user through the print setting screen (t7).

The setting management unit 122 of the print setting unit 111 sets a setting value input by the user as a print setting to cause the printer 150 to execute printing (t8). The contents of the print setting are transmitted to the application 104 (t9).

The application 104 receives the print setting sent from the print setting unit 111 at the previous t9, and stores the print setting in the DEVMODE structure (t10).

When the user sends a print request to the printer 150 on the application 104, the application 104 receives the print request (t11), and the print request is sent to the drawing unit 113 from the application 104 (t12). At this time drawing data is also sent to the drawing unit 113 with the print request.

When the drawing unit 113 receives the print request, the print setting validity confirming unit 123 of the drawing unit 113 reads the print setting stored in the DEVMODE structure (t13).

The print setting validity confirming unit 123 sends a validity determination request to the function management unit 112, to request the function management unit 112 to determine the validity of the setting value (current value) included in the read print setting (t14). The validity determination request includes the setting value (current value).

The function controlling unit 112 receives the validity determination request, and determines the validity of the setting value (current value), by referring to the function information of the printer 150 stored in the storage unit 102 (t15). At this time, the constraint conditions defined by the function information are reflected on the setting value (current value).

The function management unit 112 then sends a setting value (corrected value) that corresponds to the determination result to the print setting validity confirming unit 123 of the drawing unit 113 (t16).

When the print setting validity confirming unit 123 of the drawing unit 113 receives the determination result of the validity of the print setting from the function management unit 112(t17), the print data generating unit 124 of the drawing unit 113 generates print data interpretable by the printer 150 from the determined print setting and the drawing data (t18).

The generated print data is transmitted to the printer 150 (t19).

After transmitting the print data, the drawing unit 113 transmits a print data transmission completion notification to the application 104 (t20).

The application 104 receives the transmission completion notification from the drawing unit 113, and completes the printing operation (t21).

As described above, the function management unit 112 integrally determines the available functions of the connected printer that is performed by the print setting unit 111, and the validity of the print setting (current value) set by the user that is performed by the drawing unit 113, based on the function information of the printer. Accordingly, even if the numbers of printers supported or the functions of the printer is increased or decreased, the functions including the determination of the validity of the setting value can be managed, by just changing the function information. Consequently, it is no need to re-code the drawing unit 113 as in the conventional technology. Because the function information is prepared for each model, the printer driver is capable of adapting to the increase and decrease of the number of printers supported and the functions of the printer easily, by just changing or adding the contents at the model unit. Because the function management unit 112 integrally determines the validity, compared with when the determination of validity is separately performed by the print setting unit 111 and the drawing unit 113, the determination of validity is performed consistently.

The printer driver 106 of the embodiment described above is provided by being stored in a computer-readable recording medium that corresponds to the program product of the present invention, such as a compact disk-read only memory (CD-ROM), a flexible disk (FD), a compact disk-recordable (CD-R), a digital versatile disk (DVD), and the like in a file of an installable form or an executable form.

The programs may also be provided by being stored in a computer connected to a network such as the Internet, and by being downloaded through the network.

In the present invention, the function management unit integrally determines the available functions and the validity of the print setting, based on the function information. Accordingly, even if the number of printers supported or the functions of the printer is increased or decreased, it is possible to manage the functions including the determination of the validity of the setting value, by just changing the function information. Consequently, it is no need to re-code the printer driver as in the conventional technology.

Because the function information is prepared for each model, the printer driver of the preset invention is capable of adapting to the increase and decrease of the number of printers supported or the functions of the printer, by just changing or adding the contents at a model unit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A printer driver adapting to a plurality of models of printers, the printer driver comprising:
a function management unit that determines an available function based on function information including a constraint on a print setting;
a print setting unit that generates a print setting screen based on a determination result made by the function management unit; and
a drawing unit that generates print data in response to a request to print drawing data; wherein
the function management unit determines whether a print setting value set for the drawing data conforms to the constraint, when the drawing unit responds to the request to print the drawing data, and
the drawing unit generates print data based on determination result made by the function management unit.

2. The printer driver according to claim 1, wherein the print setting unit calls the function management unit in response to a call of a print setting screen from an application, and receives a determination result from the function management unit being called, and generates a print setting screen reflecting the determination result.

3. The printer driver according to claim 1, wherein the drawing unit calls the function management unit in response to a request to print drawing data from an application, and receives a determination result from the function controlling unit being called, and generates print data reflecting the determination result.

4. The printer driver according to claim 1, wherein the function information is provided for each model.

5. A program product comprising:
a printer driver being stored in the program product, the printer driver adapting to a plurality of models of printers, and comprising:
a function management unit that determines an available function based on function information including a constraint on a print setting;
a print setting unit that generates a print setting screen based on a determination result made by the function management unit; and
a drawing unit that generates print data in response to a request to print drawing data, wherein
the function management unit determines whether a print setting value set for the drawing data conforms to the constraint, when the drawing unit responds to the request to print the drawing data, and
the drawing unit generates print data based on determination result made by the function management unit.

6. An information processing apparatus comprising:
a printer driver adapting to a plurality of models of printers, the printer driver comprising:
a function management unit that determines an available function based on function information including a constraint on a print setting;
a print setting unit that generates a print setting screen based on a determination result made by the function management unit; and
a drawing unit that generates print data in response to a request to print drawing data, wherein
the function management unit determines whether a print setting value set for the drawing data conforms to the constraint, when the drawing unit responds to the request to print the drawing data, and
the drawing unit generates print data based on determination result made by the function management unit.

7. The information processing apparatus according to claim 6, wherein the print setting unit calls the function management unit in response to a call of a print setting screen from an application, and receives a determination result from the function management unit being called, and generates a print setting screen reflecting the determination result.

8. The information processing apparatus according to claim 6, wherein the drawing unit calls the function management unit in response to a request to print drawing data from an application, and receives a determination result from the function management unit being called, a and generates print data reflecting the determination result.

9. The information processing apparatus according to claim 6, wherein the function information is provided for each model.
